(19) United States
(12) Patent Application Publication
(10) Pub. No.: US 2020/0391816 A1
(43) Pub. Date: Dec. 17, 2020

(54) STRADDLE TYPE VEHICLE

(71) Applicant: HONDA MOTOR CO., LTD., Tokyo (JP)

(72) Inventors: Yoshiyuki KUROBA, Wako-shi (JP); Kiyoshi KATAGIRI, Wako-shi (JP); Hiroshi MAEDA, Wako-shi (JP); Tsuyoshi KUMASAKA, Wako-shi (JP)

(21) Appl. No.: 17/004,910

(22) Filed: Aug. 27, 2020

Related U.S. Application Data
(63) Continuation of application No. PCT/JP2018/011082, filed on Mar. 20, 2018.

(51) Int. Cl. B62J 23/00; B62J 99/00; B62K 19/30; B62K 21/26; B62J 45/41; G01S 15/931

(52) U.S. Cl. CPC B62J 23/00; B62J 99/00; G01S 15/931; B62K 21/26; B62J 45/41; B62K 19/30

(57) ABSTRACT

A straddle type vehicle comprising, a handle that a driver grips to steer a front wheel and a sensing device configured to detect an obstacle around a vehicle by using an ultrasonic wave, wherein the sensing device is arranged in a distal end portion of the handle.

### CROSS-REFERENCE TO RELATED APPLICATION(S)

This application is a continuation of International Patent Application No. PCT/JP2018/011082 filed on Mar. 20, 2018, the entire disclosures of which is incorporated herein by reference.

### TECHNICAL FIELD

The present invention relates to a straddle type vehicle.

### BACKGROUND ART

A straddle type vehicle including a sensing device for detecting obstacles around the vehicle is known as a straddle type vehicle including a sensing device on a side of a vehicle main body (for example, PTL1).

### CITATION LIST

### Patent Literature

PTL1: Japanese Patent Laid-Open No. 2016-503503

### SUMMARY OF INVENTION

### Technical Problem

When the sensing device is installed on a side of a vehicle main body, the detection range is sometimes blocked by a mirror or a handle existing outside the sensing device in the vehicle width direction, or by the arm, the cloth, or the like of the driver. If the detection range is blocked, the detection accuracy of the sensing device decreases.

It is an object of the present invention to provide a straddle type vehicle capable of improving the detection accuracy of the sensing device.

### Solution to Problem

According to the invention of claim 1, a straddle type vehicle (1) comprises a handle (24) that a driver grips to steer a front wheel (FW), and a sensing device (50) configured to detect an obstacle around a vehicle by using an ultrasonic wave, wherein the sensing device (50) is arranged in a distal end portion (242) of the handle (24), a cylindrical portion (243) that opens outside is formed on the distal end portion (242) of the handle (24), at least a part of the sensing device (50) is arranged in the cylindrical portion (243), and the cylindrical portion (243) has a tapered shape that expands a diameter outside in an axial direction.

According to the invention of claim 2, at least a part of a circumferential wall (244) of the cylindrical portion (243) extends outside more than the sensing device (50) in a vehicle width direction.

According to the invention of claim 3, the distal end portion (242) includes a regulating portion (245) that prevents a hand of a driver from moving outside.

According to the invention of claim 4, the regulating portion (245) increases a diameter outside in an axial direction.

According to the invention of claim 5, the straddle type vehicle further comprises a guard portion (25) arranged from a portion in front of the handle (24) to the distal end portion (242) in a vehicle longitudinal direction, and configured to protect a hand of the driver, and an electric harness (52) connected to the sensing device (50), wherein the electric harness (52) is connected to the sensing device (50) through an interior of the guard portion (25).

According to the invention of claim 6, the straddle type vehicle further includes a vibration damping member (54) interposed between the sensing device (50) and the distal end portion (242).

According to the invention of claim 7, the straddle type vehicle further comprises determining means (64) for determining whether there is an obstacle within a predetermined distance, from a detection result of the sensing device (50), and notifying means (MP) for notifying the driver of a determination result of the determining means (64), if the determining means (64) determines that the obstacle exists within the predetermined distance.

### Advantageous Effects of Invention

According to the present invention of claim 1, the sensing device is installed outside the side surface of the vehicle main body. This makes it possible to prevent the emission of an ultrasonic wave by the sensing device from being blocked by the driver or parts of the vehicle. Therefore, a straddle type vehicle capable of improving the detection accuracy of the sensing device can be provided.

Also, according to the present invention of claim 1, the sensing device can be protected because the cylindrical portion can decrease the exposure range of the sensing device.

According to the present invention of claim 2, the ultrasonic wave emitted from the sensing device is reflected by the circumferential wall and hence can be emitted to the target detection range. Also, since the circumferential wall decreases the emission angle of the ultrasonic wave, the ultrasonic wave is amplified, and the sensing performance of the sensing device can be improved.

According to the present invention of claim 3, the regulating portion makes the hand of the driver difficult to move outside, so it is possible to prevent the hand of the driver from blocking the detection range of the sensing device.

According to the present invention of claim 4, the regulating portion increases its diameter outside in the axial direction. Since this further makes the hand of the driver difficult to move outside, it is possible to prevent the hand of the driver from blocking the detection range of the sensing device more effectively.

According to the present invention of claim 5, the electric harness can be routed in the guard portion that makes routing easier than that by the handle. In addition, the electric harness can be protected because it is not exposed outside.

According to the present invention of claim 6, the vibration damping member can prevent the vibration of the handle from being transmitted to the sensing device, so a decrease in detection accuracy of the sensing device caused by the vibration can be prevented.

According to the present invention of claim 7, if the detection range of the sensing device is blocked by, for example, the hand or the cloth of the driver, the driver is notified of this information. This can encourage the driver not to block the detection range by the hand, the cloth, or the like.

### BRIEF DESCRIPTION OF DRAWINGS

FIG. 1 is a left side view of a straddle type vehicle according to an embodiment;

FIG. 2 is a plan view of the straddle type vehicle shown in FIG. 1;

FIG. 3 is a partial sectional view of the periphery of a right grip of the straddle type vehicle shown in FIG. 1;

FIG. 4 is an exploded view of the periphery of the right grip of the straddle type vehicle shown in FIG. 1; and

FIG. 5 is a block diagram of a control system of the straddle type vehicle according to the embodiment.

### DESCRIPTION OF EMBODIMENTS

A straddle type vehicle according to an embodiment of the present invention will be explained below with reference to the accompanying drawings. In each drawing, arrows X, Y, and Z indicate directions perpendicular to each other. The X direction indicates the front-and-rear direction of the straddle type vehicle, the Y direction indicates the vehicle width direction (left-and-right direction) of the straddle type vehicle, and the Z direction indicates the vertical direction. The front or rear in the front-and-rear direction of the straddle type vehicle will simply be called the front or rear in some cases. Also, the inside or outside in the vehicle width direction (left-and-right direction) of the straddle type vehicle will simply be called the inside or outside in some cases. Furthermore, when a pair of left and right parts are explained by taking one of them as an example, the other part is not shown or an explanation thereof will be omitted in some cases.

### Outline of Straddle Type Vehicle

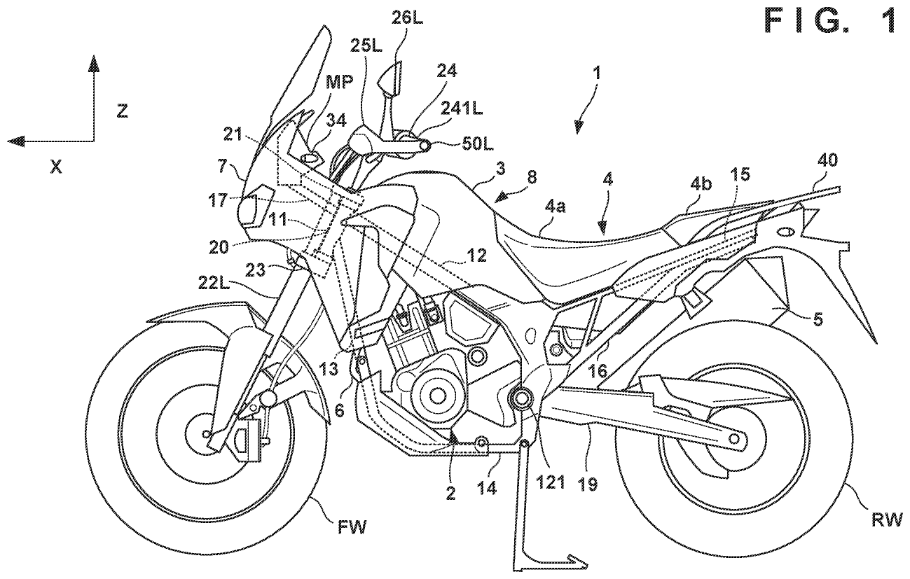

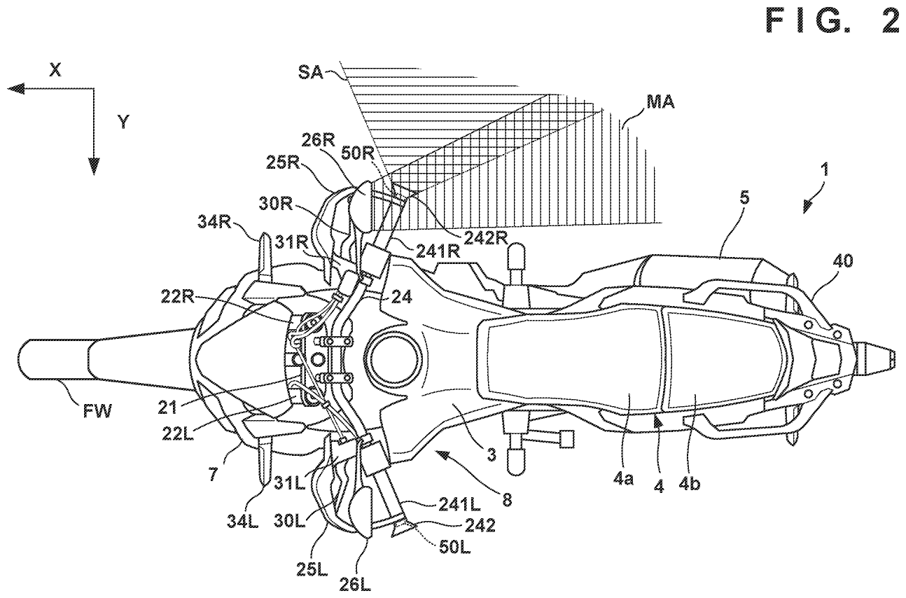

FIG. 1 is a left side view of a straddle type vehicle 1 according to the embodiment of the present invention. FIG. 2 is a plan view of the straddle type vehicle 1. The straddle type vehicle 1 is an off-road motorcycle. However, the present invention is applicable to various kinds of straddle type vehicles including motorcycles of other forms. The present invention also applicable to a vehicle including an internal-combustion engine as a driving source, and an electric vehicle including a motor as a driving source. In the following description, the straddle type vehicle 1 will sometimes be called the vehicle 1.

As a vehicle body frame, the vehicle 1 includes a head pipe 11 formed in the front part of the vehicle, a pair of left and right main frames 12, a down frame 13, a pair of left and right lower frames 14, and an extending portion 17. Each of the head pipe 11 and the down frame 13 is a single member formed along the center of the vehicle body.

The main frames 12, the down frame 13, and the lower frames 14 are connected into the form of a loop, and a power unit 2 is arranged inside a region surrounded them. The power unit 2 includes an engine and a transmission. An exhaust pipe 6 for guiding the exhaust gas of the engine to an exhaust muffler 5 is formed in front of the power unit 2.

The main frames 12 have a portion that branches into left and right parts, are attached to the upper portion of the head pipe 11, and obliquely extend downward and backward by curving to the left and right above the power unit 2. The down frame 13 is attached to the lower portion of the head pipe 11, and extends downward in front of the power unit 2 by linearly and obliquely descending in the center of the vehicle, and the lower end portion thereof is connected to the front end portions of the pair of left and right lower frames 14. The pair of left and right lower arms 14 curve from the front lower side portions of the power unit 2 to below the power unit 2 and almost linearly extend backward, and the rear end portions thereof are connected to the lower end portions of the pair of left and right main frames 12.

A fuel tank 3 supported by the main frames 12 is arranged above the power unit 2. A seat 4 is arranged immediately behind the fuel tank 3. The seat 4 includes a seat front part 4a on which a driver sits and a seat rear part 4b on which a passenger sits, and is supported on a pair of left and right seat frames 15. The pair of left and right seat frames 15 include front ends attached to the pair of left and right main frames 12, and are extended backward. A pair of left and right rear frames 16 are connected to the seat frames 15 and the main frames 12.

A grip 40 to be gripped by the passenger is formed backward from the side portions of the seat rear part 4b. The grip 40 is supported by the seat frames 15. Carriers (not shown) for storing baggage and the like can be attached to the side portions and the rear end of the grip 40.

A steering stem 20 is pivotally supported by the head pipe 11, and a top bridge 21 is attached to the upper end portion of the steering stem 20. A bottom bridge 23 is attached to the lower end portion of the steering stem 20.

A pair of left and right front forks 22L and 22R are supported by fork insertion holes (not shown) in the left and right end portions of the top bridge The pair of front forks 22L and 22R are also supported by the bottom bridge 23.

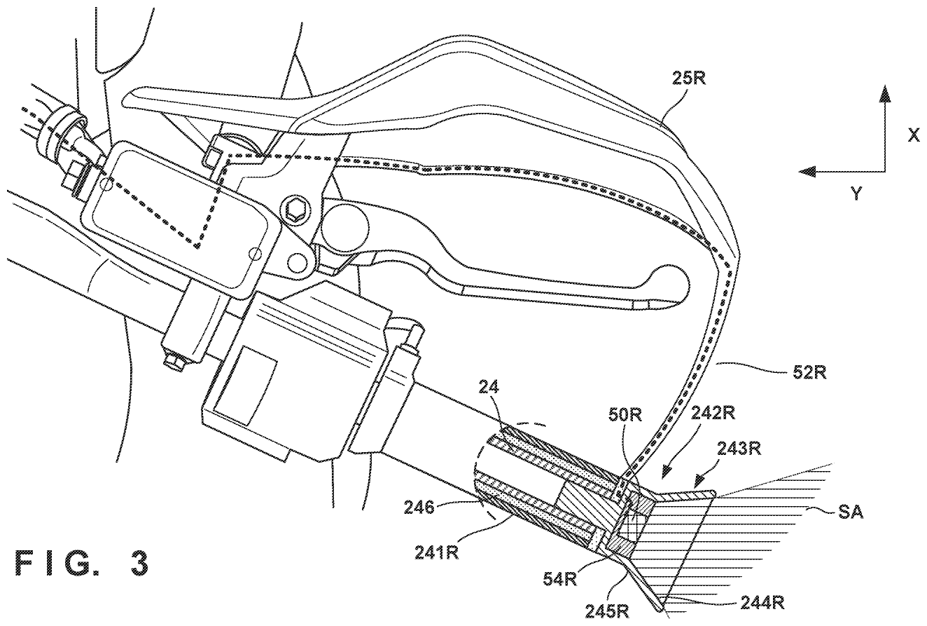

The pair of front forks 22L and 22R will also be called front forks 22 (this applies to all pairs of left and right members hereinafter). A front wheel FW is rotatably supported by the lower end portions of the front forks 22, and steered by a handle bar 24 attached to the top bridge 21. Grips 241L and 241R to be gripped by the driver are formed at the left and right end portions of the handle bar 24. In addition, brake levers 30L and 30R, and brake master cylinders 32L and 32R interconnected to the brake levers 30L and 30R, are formed adjacent to the grips 241L and 241R. Furthermore, a throttle grip 246 connected to an acceleration wire is formed on the inner diameter side of the right grip 241R (FIG. 3).

The handle bar 24 includes mirror support portions 261L and 261R extending outside in the vehicle width direction from portions inside the grips 241L and 241R. Mirrors 26L and 26R are formed on the outside end portions of the mirror support portions 261L and 261R in the vehicle width direction. As shown in FIG. 2, the driver can visually confirm a visual confirmation range MA from the side areas to the rear area by the mirrors 26L and 26R.

Sensing devices 50L and 50R (to be described later) are installed in distal end portions 242L and 242R of the handle bar 24. Guard portions 25L and 25R for protecting the hands of the driver are arranged in front of the handle bar 24 in the vehicle longitudinal direction. The guard portions 25L and 25R are supported by the brake master cylinders 32L and 32R and the distal end portions 242L and 242R of the handle bar 24.

The extending portion 17 is so formed as to extend forward from the head pipe 11, and supports a meter panel MP. The meter panel MP is a display device that displays various kinds of information, for example, the vehicle statuses such as the vehicle speed and the engine speed, and notification to the driver. In addition, a front cowl 7 is formed from the front part to the side parts of the meter panel MP, the front forks 22, and the like, so as to cover these members. Furthermore, bar winkers 34L and 34R are so formed as to project outside in the vehicle width direction from the sides of the meter panel MP.

The front end portion of a rear swing arm 19 is swingably supported by main frames 12L and 12R by using a pivot shaft 121. A rear wheel RW is supported by the rear end portion of the rear swing arm 19, and rotated by a chain (not shown) wound around a drive sprocket (not shown) of the power unit 2 and a driven sprocket (not shown) of the rear wheel RW.

### Details of Sensing Device

Details of the sensing device 50R according to this embodiment be explained below with reference to FIGS. 1 to 3. FIG. 3 is a partial sectional view of the periphery of the right grip 241R of the straddle type vehicle 1. Note that the explanation will be made by taking the right side of the handle bar 24 as an example, but the left side can have the same arrangement.

The sensing device 50R is installed in the distal end portion 242R (the right end portion in the vehicle width direction) of the handle bar 24. In this execution publication, the distal end portion 242R has a cylindrical shape, and the sensing device 50R is inserted into this cylindrical shape. The sensing device 50R can detect obstacles around the vehicle 1, and is an integrated transmitter/receiver type ultrasonic sensor (sonar) in this embodiment. As shown in FIG. 2, the distal end portion 242R of the handle bar 24 is positioned outside, in the vehicle width direction, of the vehicle main body 8 including the fuel tank 3 and the front cowl 7. Accordingly, the sensing device 50R is positioned outside the vehicle main body 8 in the vehicle width direction.

Referring to FIGS. 2 and 3, a detection range SA of the sensing device can be defined by the relationship with the visual confirmation range MA of the mirror 26. For example, the detection range SA of the sensing device 50R can be so defined as to cover the outside of the visual confirmation range MA of the mirror, that is, the dead angle of the driver.

Also, as shown in FIG. 1, the sensing device 50R is arranged at the height of the handle bar 24, and hence is higher from the road surface than when it is arranged on the side surface of the vehicle main body 8. Accordingly, noise produced by road surface reflection can be suppressed more than that when the sensing device 50R is arranged on the side surface of the vehicle main body 8.

In addition, the distal end portion of the handle bar 24 generally has a handle weight in order to suppress the vibration of the handle and secure the safety of the vehicle body. In this embodiment, the sensing device 50R can be used instead of the handle weight because the sensing device 50R itself has a weight.

As shown in FIG. 3, the distal end portion 242R of the handle bar includes a cylindrical portion 243R that opens outside. In this embodiment, the sensing device 50R is supported inside the cylindrical portion 243R so as to he surrounded by a circumferential wall 244R. Note that only a part of the sensing device 50R may be arranged inside the cylindrical portion 243R, and at least a part of the circumferential wall 244R of the cylindrical portion 243R may be extended outside the sensing device 50R in the vehicle width direction.

In this embodiment, the sensing device 50R is supported by the distal end portion 242R via a vibration damping member 54R. The vibration damping member 54R is a member that suppresses the vibration of the handle bar 24 from being transmitted to the sensing device 50R. As the vibration damping member 54R, it is possible to adopt, for example, a metal member such as an antivibration alloy or an elastic member such as antivibration rubber.

A regulating portion 245R for preventing the hand of the driver from moving outside is formed on the right grip 241R of the handle bar 24. In this embodiment, the regulating portion 245R has a tapered shape that expands its diameter outside in the axial direction of the grip 241R. The shape of the regulating portion 245R is not limited to this, and need only be a shape different from the shapes of other positions of the grip 241R so that the driver can recognize the regulating portion 245R. For example, it may be possible to make the diameter of the regulating portion 245R larger than those of other positions, or form a flange. One or a plurality of projections may be formed.

The vehicle 1 further includes electric harnesses 52L and 52R for connecting the sensing devices 50 to a control unit 64 (to be described later). As indicated by the broken line in FIG. 3, the electric harness 52R extends from the sensing device 50R to the control unit 64 through the interiors of the guard portions 25L and 25R. The detection results obtained by the sensing device 50R are output to the control unit 64 via the electric harnesses 52L and 52R.

The sensing device 50R is so arranged that the detection range SA is the side area or the rear area of the vehicle 1. In this case, the circumferential wall 244R may be formed to extend in the direction matching the detection range SA, on the outside of the sensing device 50R in the vehicle width direction. In this embodiment, the circumferential wall 244R is formed to increase the diameter in the direction matching the detection range SA.

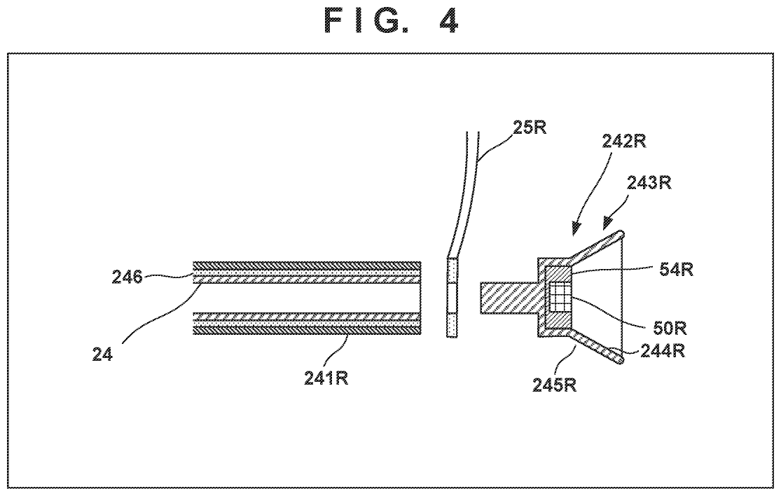

FIG. 4 is an exploded view of the periphery of the right grip 241R of the straddle type vehicle 1. In this embodiment, the cylindrical portion 243R of the handle bar 24 is formed independently of the handle bar 24. The cylindrical portion 243R is attached to the handle bar 24 with the guard portion 25R being sandwiched between them. That is, the guard portion 25R is supported as it is sandwiched between the handle bar 24 and the cylindrical portion 243R.

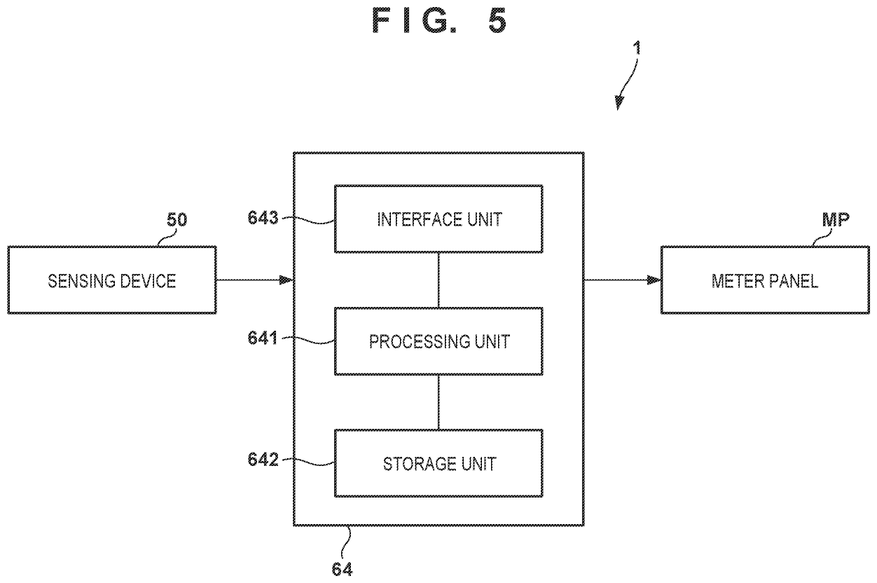

FIG. 5 is a block diagram of the control system of the vehicle 1, particularly, a block diagram of the control unit 64 for controlling the sensing device 50 and the meter panel MP. The control unit 64 causes the meter panel MP to also function as a notification unit that displays information of the periphery of the vehicle, and controls the display based on the detection result of the sensing device 50. The control unit 64 includes a processing unit 641, a storage unit 642 such as a RAM or a ROM, and an interface unit 643 for relaying exchange of signals between an external device and the processing unit 641. The processing unit 641 is a processor such as a CPU and executes programs stored in the storage unit 642. The storage unit 642 stores the programs to be executed by the processing unit 641, and various kinds of data. The interface unit 643 receives the detection result from the sensing device 50 via a signal processing circuit (not shown).

An example of processing to be executed by the processing unit 641 will be explained. As basic processing, the processing unit 641 determines the presence/absence of an obstacle such as a nearby vehicle based on the input detection result from the sensing device 50. If the processing unit 641 determines that there is an obstacle in the periphery, the processing unit 641 notifies the driver by displaying the information on the meter panel MP. For example, the meter panel MP turns on an indicator indicating the approach of the nearby vehicle, or displays characters indicating the approach of the vehicle on the display surface of the meter panel MP.

On the other hand, if the processing unit 641 determines that the input detection result from the sensing device 50 is an abnormal value or there is an obstacle within a predetermined distance, the processing unit 641 performs notification that encourages the driver not to cover the sensing device 50. The predetermined distance can also be set at, for example, a distance at which the hand or the cloth of the driver may cover the sensing device 50. In this case, the processing unit 641 causes the meter panel MP to perform display in a form different from that of the basic processing described above. For example, the meter panel MP turns on an indicator different from that of the basic processing, or displays characters that encourage the driver not to cover the sensing device 50. This display can encourage the driver not to block the detection range SA.

As another example of the form of notification to the driver, the vehicle 1 can further include a speaker (not shown) or the like, and this speaker or the like can generate an alarm sound in accordance with an instruction from the control unit 64. It is also possible to combine the indicator and the alarm sound.

### Effects

In this embodiment as has been explained above, the sensing device 50R is installed outside the side surface of the vehicle main body 8. This makes it possible to prevent the emission of an ultrasonic wave by the sensing device 50R from being blocked by, for example, the arm or the cloth of the driver, or by parts of the vehicle. That is, the detection accuracy of the sensing device 50R can be improved.

Also, the sensing devices 50L and 50R can be protected because the cylindrical portions 243L and 243R decrease the exposure range of the sensing device 50R. In addition, the ultrasonic waves emitted from the sensing devices 50L and 50R are reflected by the circumferential walls 224L and 224R of the distal end portions 242L and 242R, and hence can be emitted to the target detection ranges. Furthermore, since the circumferential walls 244L and 244R decrease the emission angles of the ultrasonic waves, the ultrasonic waves are amplified, and the sensing performance of the sensing devices 50L and 50R can be improved.

Moreover, the regulating portions 245L and 245R make the hands of the driver difficult to move outside, so it is possible to prevent the hands of the driver from blocking the detection ranges of the sensing devices 50L and 50R. Furthermore, the regulating portions 245L and 245R increase their diameters outside in the axial direction. Since this further makes the hands of the driver difficult to move outside, it is possible to prevent the hands of the driver from blocking the detection ranges of the sensing devices 50L and 50R more effectively.

Also, since the guard portions 25L and 25R are formed in front of the handle bar 24, the electric harnesses 52L and 52R can be routed in the guard portions 25L and 25R that make routing easier than that by the handle bar 24. In addition, the electric harnesses 52L and 52R are not exposed outside because they pass through the guard portions 25L and 25R, so the electric harnesses 52L and 52R can be protected.

Furthermore, the vibration damping members 54L and 54R can prevent the vibration of the handle bar 24 from being transmitted to the sensing devices 50L and 50R, so a decrease in detection accuracy of the sensing devices 50L and 50R caused by the vibration can be prevented.

Also, if a determining means 60 determines that the detection ranges of the sensing devices 50L and 50R are blocked by, for example, the hand or the cloth of the driver, a notifying means 62 notifies the driver of the determination result. This can encourage the driver not to block the detection range by the hand, the cloth, or the like.

### Other Embodiments

An example in which the bar type handle is adopted has been explained in the above embodiment, but separate type handles can also be adopted. In this case, the sensing devices 50 can be installed in the distal end portions positioned outside in the vehicle width direction. In addition, an example in which the cylindrical portions 243 are provided independently of the handle bar 24 has been explained in the above embodiment. However, an arrangement in which the cylindrical portions are integrated with the handle can also be adopted.

### REFERENCE SIGNS LIST

1 . . . straddle type vehicle, 24 . . . handle bar, 50 . . . sensing device

1. A straddle type vehicle comprising:
a handle that a driver grips to steer a front wheel; and
a sensing device configured to detect an. obstacle around a vehicle by using an ultrasonic wave,
wherein the sensing device is arranged in a distal end portion of the handle,
a cylindrical portion that opens outside is formed on the distal end portion of the handle,
at least a part of the sensing device is arranged in the cylindrical portion, and
the cylindrical portion has a tapered shape that expands a diameter outside in an axial direction.

2. The straddle type vehicle according to claim 1, wherein at least a part of a circumferential wall of the cylindrical portion extends outside more than the sensing device in a vehicle width direction.

3. The straddle type vehicle according to claim 1, wherein the distal end portion includes a regulating portion that prevents a hand of a driver from moving outside.

4. The straddle type vehicle according to claim 3, wherein the regulating portion expands a diameter outside in an axial direction.

5. The straddle type vehicle according to claim 1, further comprising:
a guard portion arranged from a portion in front of the handle to the distal end portion in a vehicle longitudinal direction, and configured to protect a hand of the driver; and
an electric harness connected to the sensing device,
wherein the electric harness is connected to the sensing device through an interior of the guard portion.

6. The straddle type vehicle according to claim 1, further comprising a vibration damping member interposed between the sensing device and the distal end portion.

7. The straddle type vehicle according to claim 1, further comprising:
determining means for determining whether there is an obstacle within a predetermined distance, from a detection result of the sensing device; and
notifying means for notifying the driver of a determination result of the determining means, if the determining means determines that the obstacle exists within the predetermined distance.
